(19) United States
(12) Patent Application Publication
(10) Pub. No.: US 2025/0007021 A1
(43) Pub. Date: Jan. 2, 2025

(54) Method for recovery of cathode materials, cathode materials and electric vehicles

(71) Applicants: Microvast, Inc., Stafford, TX (US); Virginia Polytechnic Institute and State University, Blacksburg, VA (US)

(72) Inventors: Jinsuo ZHANG, Blacksburg, VA (US); Mingyang ZHANG, Blacksburg, VA (US); Yun XU, Lake Mary, FL (US); Bryan Yonemoto, Lake Mary, FL (US); Wenjuan Liu Mattis, Lake Mary, FL (US)

(21) Appl. No.: 18/215,191

(22) Filed: Jun. 28, 2023

(51) Int. Cl. H01M 10/54; C22B 1/00; C22B 3/26; C22B 26/12; C22B 26/20

(52) U.S. Cl. CPC H01M 10/54; C22B 1/005; C22B 3/26; C22B 26/12; C22B 26/20

(57) ABSTRACT

The main purpose of the invention is to provide a method for recovery of cathode materials, cathode materials and electric vehicles. The method for recovery of cathode materials comprises the following steps: step 1, adding cathode materials and a metal reducing agent (MRA) to a molten salt (MS), the cathode materials and the MRA performing a reduction reaction in MS to obtain precipitates and MS solutions. By using the method for recovery of cathode materials of the present invention, main metal elements in cathode materials of a secondary battery are effectively recovered, and compared with pyrometallurgical or hydrometallurgical methods in the prior art, the recovery rate of a metal mixture can reach unexpected 90% or more. Furthermore, the method of the present invention is environmentally friendly, all raw materials can be recycled and reused and no exhaust gases or waste liquids contaminating the environment are discharged.

This invention was made with government support under 1738689 awarded by the National Science Foundation. The government has certain rights in the invention.

### TECHNICAL FIELD

The prevent invention relates to the field of a method for recovery of materials, and particularly relates to a method for recovery of cathode materials, cathode materials and electric vehicles.

### BACKGROUND

Secondary batteries are widely used and are commonly used in fields such as mobile electronic devices, medical devices, energy storage systems and electric vehicles, and at the same time, the productivity increases year by year. Corresponding to this, resource requirements including lithium and various colored metals and the influence of waste batteries and production wastes on the environment are also growing gradually, and thus the recovery of materials related to secondary batteries is increasingly important.

The cathode materials of secondary batteries mainly include oxide materials (such as lithium cobaltate, ternary material, etc.) and lithium iron phosphate materials, and the recovery methods thereof are different. Lithium cobaltate can be recovered by hydrometallurgical processes. Firstly, lithium cobaltate and potassium hydroxide in waste batteries are mixed and heated to 100° C. or higher so that same is dissolved into Co(OH)₂. The obtained Co(OH)₂ is then subjected to precipitation separation using hydrochloric acid or sulfuric acid, and finally the precipitate is washed with water and dried to obtain a reusable Co₂O₄ powder with a higher purity. Waste lithium iron phosphate batteries can be recovered by chemical reduction or electrolytic reduction. Very fine powder morphology and high purity are requirements that the powder needs to meet in large scale production processes. For a ternary cathode material generally used in the electric vehicle industry, two methods of hydrometallurgy and pyrometallurgy are mainly adopted currently. Pyrometallurgy generally refers to direct calcination or reduction, and requires the addition of a reducing agent to remove carbonaceous deposits therein. In hydrometallurgy, waste ternary cathode materials are decomposed into a single metal salt under strong alkaline conditions, and then decolorization, sublimation, reaction and other processes are performed to prepare a novel particle morphology.

An example of recovering cathode materials of lithium ion batteries by pyrometallurgy in the prior art, CN 109786739 A discloses a method for recovering cathode materials of lithium batteries by molten salt-assisted carbonthermal reduction, comprising disassembling lithium batteries to obtain cathode materials of the lithium batteries; processing the lithium battery cathode materials to obtain an active substance, lithium cobaltate; performing molten salt-assisted carbothermal reduction to obtain a co-crystal mixture powder of a calcium-based molten salt, wherein the melting temperature of the calcium-based molten salt is less than or equal to 700° C.; subjecting the mixture powder to a heat preservation treatment at 600-900° C. under a mixed vacuum condition for 30-75 min to obtain a mixed product of cobalt, calcium carbonate and a lithium salt; step 3: dissolving the mixed product of cobalt, calcium carbonate, and a lithium salt in water to obtain a mixed solution of cobalt, calcium carbonate, and Li-ion, performing magnetic separation on the mixed solution of cobalt, calcium carbonate and Li-ion, so as to obtain a mixed solution of cobalt and remaining calcium carbonate and Li-ion; adding sodium sulfate to a mixed solution containing calcium carbonate and Li-ion, producing a calcium sulfate precipitate, and filtering to obtain a calcium-based precipitate and a Li-ion-containing filtrate; adding sodium carbonate into the Li-ion-containing filtrate to obtain a mixed solution of lithium carbonate precipitate, and filtering to obtain lithium carbonate. However, this method affects the environment by releasing harmful gases during processing.

Therefore, there is a need to develop a novel method for recovery of cathode materials to more efficiently recover metal elements in cathode materials without emission of harmful substances.

### SUMMARY

The main purpose of the invention is to provide a method for recovery of cathode materials, cathode materials and electric vehicles, so as to solve the problem that the method in the prior art cannot be used for effectively recovering elemental metal in cathode materials.

In order to achieve the purpose above, according to one aspect of the present invention, provided is a method for recovery of cathode materials, comprising: Step 1, adding cathode materials and a metal reducing agent (MRA) to a molten salt (MS), the cathode materials and the MRA performing a reduction reaction in MS to obtain precipitates and MS solutions.

In the method for recovery of cathode materials, the operating temperature of the reduction reaction in step 1 is higher than the melting temperature of the MS.

In the method for recovery of cathode materials, the operating temperature of the reduction reaction in step 1 is 50-100° C. higher than the melting temperature of the MS.

In the method for recovery of cathode materials, the operating temperature of the reduction reaction in step 1 is in the range of 500-900° C.

In the method for recovery of cathode materials, in the step 1, the MS can dissolve at least 2 mole % of the MRA, and can dissolve at least 20 mole % of an MRA oxide.

In the method for recovery of cathode materials, the MRA and the MS have at least one same metal element.

In the method for recovery of cathode materials, the MRA and the MS are the combination selected from the following group: elemental lithium and lithium chloride, elemental potassium and potassium chloride, elemental calcium and calcium chloride, elemental calcium and calcium fluoride, elemental aluminum and sodium hexafluoroaluminate, and elemental calcium and an eutectic mixture of calcium chloride and calcium fluoride.

In the method for recovery of cathode materials, the MS is single molten salt or eutectic molten salt.

In the method for recovery of cathode materials, the weight ratio of the cathode materials to the MRA is less than 1.3.

In the method for recovery of cathode materials, the weight ratio of the MS to the cathode materials is in the range of 7 5 to 55.

In the method for recovery of cathode materials, the MRA used in step 1 is calcium and the MS is calcium chloride.

In the method for recovery of cathode materials, the method further comprising: Step 2, leaching the precipitates using an organic solvent, so as to obtain a first supernatant and a first filter product; and Step 3, rinsing the first filter product to obtain a solid product and rinse wastewater, wherein the solid product is a metal alloy apart from lithium. Or the solid product is a critical metal alloy apart from lithium.

In the method for recovery of cathode materials, the operating temperature of step 2 is in the range of 50-100° C.

In the method for recovery of cathode materials, the rinsing of the step 3 is performed with deionized water at room temperature.

In the method for recovery of cathode materials, the cathode materials are obtained by the following steps: disassembling a secondary battery to obtain a cathode, removing a cathode electrode current collector and a binder from the cathode, so as to obtain the cathode materials.

In the method for recovery of cathode materials, the organic solvent comprises dimethyl sulfoxide (DMSO), formamide, ethylene carbonate, propylene carbonate, and ethylenediamine.

In the method for recovery of cathode materials, the method further comprises the following steps: step 4, cooling the MS solutions obtained in step 1 to obtain a solid salt, and then using an organic solvent to leach the solid salt, so as to obtain a second supernatant and a second filter product; and step 5, mixing the first supernatant with the second supernatant to obtain a mixed supernatant, and vacuum distilling the mixed supernatant to recover the organic solvent and the molten salt.

In the method for recovery of cathode materials, the recovered organic solvent is used as the organic solvent in step 2 and/or the recovered molten salt is used as the MS in step 1.

In the method for recovery of cathode materials, the method further comprises the following step: step 6, mixing a second filter product with the rinse wastewater obtained from the step 3 to obtain a waste liquid to be treated, and adding a carbonate salt into the waste liquid to be treated. so as to recover lithium carbonate.

In the method for recovery of cathode materials, step 6 further comprises: adding a first amount of carbonate salt to the waste liquid to be treated, so as to precipitate calcium ions in the form of calcium carbonate, the molar ratio of the first amount of carbonate salt and the MRA (Ca) being in the range of 1:1-1:1.2; then adding a second amount of carbonate salt to the waste liquid to be treated, so as to precipitate lithium ions in the form of lithium carbonate, and recovering the lithium carbonate, the weight ratio of the second amount of carbonate salt and the cathode materials being in the range of 0.6 to 2.

In the method for recovery of cathode materials, the precipitated calcium carbonate is subjected to sintering treatment and thermite reaction to obtain calcium metal, and the obtained elemental calcium can be used as the MRA of step 1.

According to one aspect of the present invention, provided are cathode materials which are prepared by the alloy recovered by the method for recovery of cathode materials as described above.

According to one aspect of the present invention, provided is an electric vehicle, which comprise the cathode material as described above.

By using the method for recovery of cathode materials of the present invention, main metal elements in cathode materials of a secondary battery are effectively recycled, and compared with pyrometallurgical or hydrometallurgical methods in the prior art, the recovery rate of a metal mixture can reach unexpected 90% or more. Furthermore, the method of the present invention is environmentally friendly, all raw materials can be recycled and reused and no exhaust gases or waste liquids contaminating the environment are discharged.

### BRIEF DESCRIPTION OF THE DRAWINGS

The accompanying drawings, which form a part of the present application, are used to provide a further understanding of the present invention. The schematic embodiments of the present invention and the description thereof are used to explain the present invention, and do not form improper limits to the present invention. In the drawings:

FIG. 1 shows a flow diagram for recovery of cathode materials according to one embodiment of the present invention.

FIG. 2 shows a flow diagram for recovery of cathode materials according to one embodiment of the present invention.

FIG. 3 shows a flow diagram for recovery of cathode materials according to an embodiment of the present invention.

FIG. 4 shows a flow diagram for recovery of cathode materials according to one embodiment of the present invention.

FIG. 5 shows a flow diagram for recovery of cathode materials according to one embodiment of the present invention.

### DETAILED DESCRIPTION OF THE EMBODIMENTS

It is important to note that the embodiments of the present disclosure and the characteristics in the embodiments can be combined under the condition of no conflicts. The present disclosure will be described below with reference to the drawings and embodiments in detail.

As explained in the background art, in the prior art, the methods for recovery of cathode materials may discharge harmful gases or waste liquids that contaminate the environment, and the recovery efficiency is not satisfactory. In view of the problems in the prior art, according to a typical embodiment of the present invention, provided is a method for recovery of cathode materials, comprising: step 1, adding cathode materials and a metal reducing agent (MRA) to a molten salt (MS), the cathode materials and the MRA performing a reduction reaction in MS to obtain precipitates and MS solutions.

Unlike the method for recovery of cathode materials in the prior art, the method for recovery of cathode materials in the present invention uses molten salt as a solvent, a catalyst, and an extraction agent, therefore, after main alloys of the cathode materials are recovered, the molten salt does not cause gas of liquid emissions contaminating the environment. Both the metal reducing agent and the molten salt used in the method of the present invention can be recycled. The molten salt can act as a catalyst to catalyze the reduction reaction of the cathode materials, and can increase the contact between a reactant, such as a metal reducing agent (such as Ca, K, Li or Al), and anode materials, such as Lithium nickel manganese cobalt oxides material, thereby accelerating the reaction speed. The molten salt of the present invention may also serve as a solvent for the reduction reaction. After the cathode material and the metal reducing agent are added to the molten salt, the molten salt may effectively dissolve the reactant metal reducing agent and byproducts (metal oxides) that may be generated by the reaction, thereby ensuring that after the reduction reaction, the solid product precipitated at the bottom of the solvent contains only the main metal alloys in the cathode materials. Thus, the recovery rate of the recovery method of the present invention is effectively improved. When the molten salt is used as the extraction agent, a metal oxide which cannot participate in the reaction or a metal oxide produced by a side reaction can be extracted, and Li (specifically) can be recovered in a subsequent step, thereby further improving the recovery rate of the recovery method of the present invention.

In the method of the present invention, the MS can dissolve at least 2 mol % of the MRA, and the MS can dissolve at least 20 mol % of an MRA oxide. In various embodiments of the present invention, the MS can dissolve at least 10 mol % of the MRA, or 20 mol % of the MRA, or 40 mol % of the MRA. And in various embodiments of the present invention, the MS can dissolve at least 20 mol % of an MRA oxide, or at least 40 mol % of an MRA oxide. The MRA oxide refers to the by-product of the reduction reaction and refers to the MRA's stable valence in the selected MS. In general, the MRA oxide comprises the oxides of the MRA, such as CaO, K₂O, Na₂O, Li₂O, Al₂O₃ and the like. In the process of adding the MRA to the MS, as the MRA has a higher solubility in the MS, a large amount of the MRA can be dissolved in the MS in the production process, so that the MRA can be fully in contact with the cathode material added to the MS and the reduction reaction can be performed continuously. In addition, an MRA oxide will be produced during the process of completely reducing the cathode material to a metal alloy, which oxide can be dissolved into the MS with relatively high solubility. After the reduction reaction is completed completely, the MS solution will contain the unwanted MRA oxide and unreacted MRA, so that the resulting precipitate only contains the reduced metal alloy and a small amount of impurities, thereby improving the recovery efficiency of the present invention. In some embodiments of the present invention, the MRA and MS used have at least one same metal element, and in this case, the solubility of the MRA and the MRA oxide in the MS can be further improved, thereby improving the efficiency of the reduction reaction and the recovery efficiency.

The cathode materials used in the described method of the present invention may be cathode materials disassembled from waste lithium ion secondary batteries. In this case, the method for recovery of cathode materials of the present invention further comprises disassembling lithium ion secondary batteries to obtain a cathode, and removing a cathode current collector and a binder from the cathode to obtain the cathode materials. In a more specific embodiment, this step further comprises disassembling the lithium ion secondary batteries, removing the cathode current collector from the cathode sheet by means of mechanical peeling, and then removing the impurities containing the binder by means of combustion to obtain the cathode materials

In some embodiments of the invention, the cathode material may be a ternary cathode material such as nickel cobalt lithium aluminate (NCA) or nickel cobalt lithium manganate (NMC). Specific examples may be LiₓNi_{y}Co_{z}Al_{1-y-z}O₂ (1≤x≤1.2, 0.5≤y≤1, and 0≤z≤0.5) or LiNiₓCo_{y}Mn_{z}O₂ (x+y+z=1, 0<x<1, 0<y<1, 0<z<1) Specific examples of the cathode material may include, but are not limited to, LiNiO₂, LiCoO₂, LiCo_{0.99}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂ and Li_{1.15}(Mn_{0.55}Ni_{0.22}Co_{0.13})O₂, LiFePO₄, LiMnPO₄, LiFe_{0.5}Mn_{0.5}PO₄ and LiFe_{0.3}Mn_{0.7}PO₄.

In some embodiments, the MRA and MS used in the method of the present invention comprise at least one same metal element, and the combination of the MRA and the MS can include elemental lithium (MRA) and lithium chloride (MS), elemental potassium (MRA) and potassium chloride (MS), elemental calcium (MRA) and calcium chloride (MS), elemental calcium (MRA) and calcium fluoride (MS), and elemental aluminum (MRA) and sodium hexafluoroaluminate (MS). In case the MS used is an eutectic molten salt, the MRA and the MS used may be elemental calcium (MRA) and a molten mixture of calcium chloride and calcium fluoride (eutectic molten MS).

In the embodiment where the MRA is calcium and the corresponding MS is calcium chloride, the method for recovery of cathode materials of the present invention may further comprises Step 2,leaching the precipitates using an organic solvent, so as to obtain a first supernatant and a first filter product; and Step 3, rinsing the first filter product to obtain a solid product and rinse wastewater, wherein the solid product is a metal alloy apart from lithium. Or the the solid product is a critical metal alloy apart from lithium.

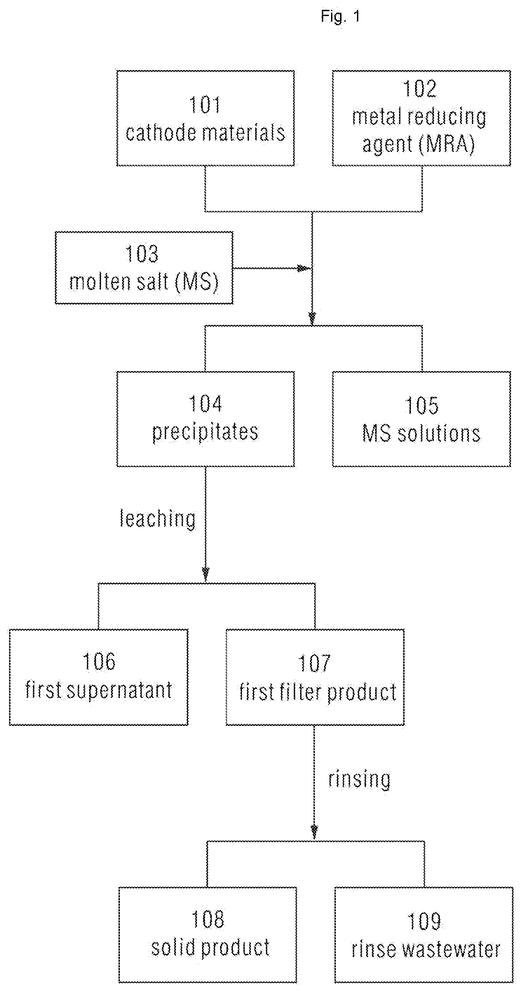

Referring to FIG. 1, in one embodiment of the present invention, the method for recovery of cathode materials of the present invention comprises adding a cathode material 101 and a metal reducing agent (MRA) 102 to a molten salt (MS) 103, wherein MS is present as a solvent, a catalyst and an extraction agent. In some examples, the metal reducing agent (MRA) 102 may first be added to the molten salt (MS) 103 to enable complete dissolution of the MRA in the MS, followed by addition of the cathode material to the MS. Alternatively, in some alternative embodiments, the cathode material 101 may be pre-mixed with the metal reducing agent (MRA) 102 prior to being added to the molten salt (MS) 103. No matter which addition method is used, the solubility of the MRA in the MS should be ensured, and the MRA is in sufficient contact with the cathode material to complete the reduction reaction. In the MS103, a reduction reaction occurs between the cathode material 101 and the MRA102, so that the cathode material is reduced to a metal element, and a precipitate 104 and an MS solution 105 are generated after the reaction is completed. The MS solution 105 is a mixture with the MS as solvent, and contains various oxides and impurity components that may be generated in the reduction reaction. A leaching operation is performed on the precipitate 104 to obtain a first supernatant 106 and a first filter product 107, optionally wherein the leaching operation is performed using an organic solvent as the leaching liquid. After leaching, the mixture of reduced metal elements remains in the first filter product 107. The leaching operation removes only further impurities that may be present such as MS. After leaching, the first filter product 107 is subjected to a rinsing operation to provide a solid product 108 and rinse wastewater 109. The rinsing operation removes soluble metal impurities, such as hydroxides, attached to the solid product 108, resulting in a pure solid product 108. The solid product 108 obtained by the described method of the present invention comprises only the alloys of the main metals used in the cathode material and does not contain active metal components such as lithium. By means of the described method of the present invention, main metals in waste cathode materials can be effectively recovered and compared with a pyrometallurgical method or a hydrometallurgical method in the prior art, the method has a better recovery efficiency, and the recovery rate of a metal mixture can reach unexpected 90% or more.

In the method above, the reduction reaction temperature of the cathode material 101 and the metal reducing agent (MRA) 102 should be higher than the melting temperature of the MS103, so as to ensure that the MS is in a molten state during the reaction, and the MRA and the generated by-product or metal oxide can be dissolved in the MS. In a further embodiment, the reduction reaction is operated at a temperature 50-100° C. higher than the melting temperature of the MS. In another embodiment, the reduction reaction is operated at a temperature in the range of 500-900° C. The above-mentioned temperature range is lower than an operating temperature of a pyrometallurgical method generally used in the prior art and higher than an operating temperature of a hydrometallurgical method. Therefore, the process of the present invention has higher recovery efficiency than a hydrometallurgical method but consumes less energy than a pyrometallurgical method.

In various embodiments of the present invention, the operating temperature of the reduction reaction may be in the range of 500-900° C., 550-850° C. 600-800° C., 650-750° C., 500-700° C., 500-750° C., 500-800° C., 500-850° C., 700-750° C., 700-800° C., 700-850° C., or 700-900° C.

In some embodiments of the present invention, the leaching operation of step 2 may be carried out in a temperature range of 50-100° C. In various embodiments of the present invention, the leaching operation of step 2 may be in the range of 50-100° C., 60-95° C., 70-90° C., 80-85° C., 50-95° C., 50-90° C., 50-85° C., 50-80° C., 50-75° C., 50-70° C., 70-100° C., 75-100° C., 80-100° C., 85-100° C., or 90-100° C. Within the temperature range above, the MS attached to the surface of the metal alloy can be effectively removed. In other embodiments, the rinse operation of step 3 can be carried out using deionized water at room temperature. The soluble metal impurities, such as hydroxides, attached to the solid product can be removed using deionized water to yield a pure metal alloy. In the present invention, the MS used may be a single molten salt or eutectic molten salt. In the case of the eutectic molten salt used, two or more kinds of single molten salts may be used. In some embodiments, the weight ratio of the cathode material to the MRA is less than 1.3 such that material is not wasted in cases where the MRA is used to completely reduce important metal elements in the cathode material. In addition, the weight ratio of the MS to the cathode material used should be in the range of 7.5 to 55.

In various embodiments of the present invention, the weight ratio of the MS to the cathode material used should be in the range of 7.5 to 55, 8 to 55, 9 to 55, 10 to 55, 11 to 55, 12 to 55, 13 to 55, 14 to 55, 15 to 55, 20 to 55, 25 to 55, 30 to 55, 35 to 55, 40 to 55, 45 to 55, 50 to 55, 8 to 65, 8 to 50. 8 to 45, 8 to 40, 8 to 30 or 8 to 30.

According to some embodiments of the invention, the organic solvent that may be used when leaching the precipitate in step 2 includes, but is not limited to, dimethyl sulfoxide (DNSO), formamide, ethylene carbonate, propylene carbonate, and ethylene diamine. In another embodiment, the organic solvent used is DMSO.

In a further embodiment of the present invention, the method for recovery of cathode materials further comprises step 4, cooling the MS solution obtained in step 1 to obtain a solid salt, and then leaching the solid salt with an organic solvent to obtain a second supernatant and a second filter product; and step 5, mixing the first supernatant and the second supernatant to obtain a mixed supernatant, and vacuum distilling the mixed supernatant to recover the organic solvent and the molten salt.

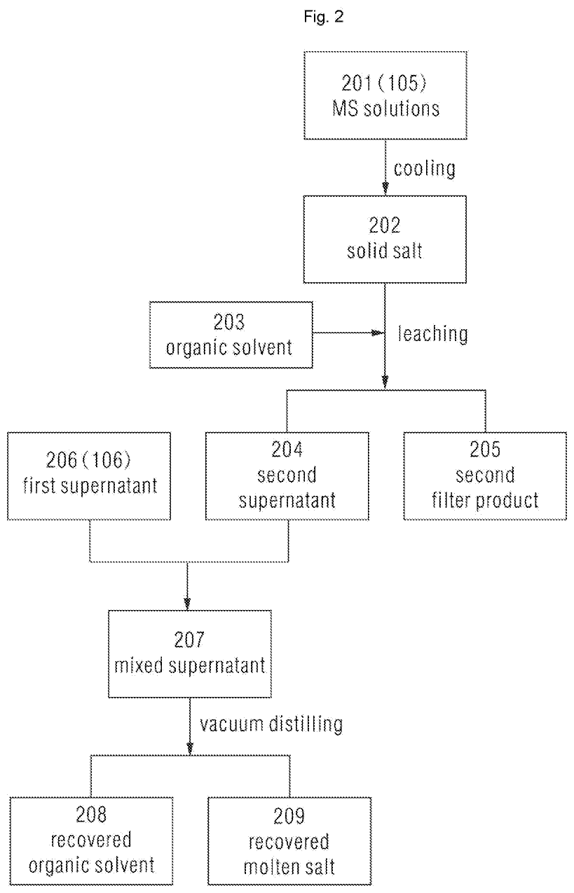

Referring to FIG. 2. in a specific embodiment, an MS solution 201 (previously described as the MS solution 105) is cooled to obtain a solid salt 202, and the solid salt 202 is then leached using an organic solvent 203. The organic solvent 203 used in the leaching step may be the same or different from the organic solvent previously described. A second supernatant 204 and a second filter product 205 are obtained by leaching using an organic solvent The second filter product 205 comprises an MRA oxide, unreacted MRA, and oxides of other metals that may be present in the cathode materials. The second supernatant 204 comprises the organic solvent 203 and the MS. After the leaching step, the first supernatant 206 (previously described as the first supernatant 106) is mixed with the second supernatant 204 to obtain a mixed supernatant 207. The first supernatant 206 and the second supernatant 204 comprise substantially the same constituents. The organic solvent is separated from the MS in the mixed supernatant 207 by vacuum distillation, resulting in recovered organic solvent 208 and recovered MS 209. Through the leaching and recovery steps of this embodiment, the MS and the organic solvent used in the inventive method for recovery of cathode materials may be efficiently recovered, thereby reducing or even completely avoiding material waste and possible environmental hazards.

After the organic solvent and molten salt are recovered, the recovered organic solvent may be used as the organic solvent in step 2 above, and/or the recovered MS may be used as the MS used in step 1 above in the description, thereby saving the costs of the method of the present invention.

In a further embodiment, the method for recovery of cathode materials according to the present invention can further comprise step 6 of mixing the second filter product with the rinse wastewater obtained in step 3 to obtain a waste liquid to be treated, and adding a carbonate into the waste liquid to be treated, so as to recover lithium carbonate.

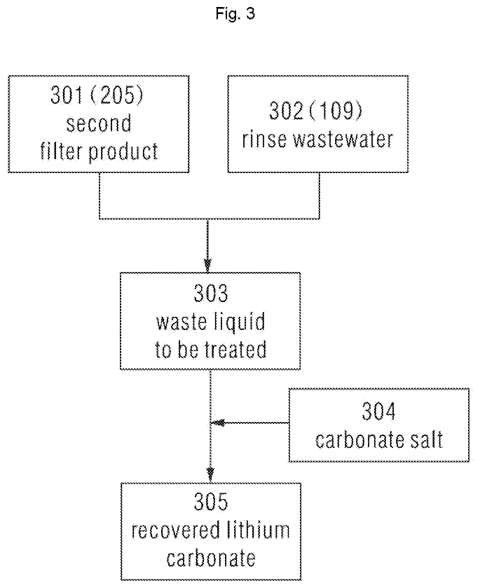

According to the present invention, the lithium ion also may be recovered. In the embodiment where the MRA is calcium and the corresponding MS is calcium chloride, referring to FIG. 3, in a specific example, a second filter product 301 (previously described as the second filter product 205) is mixed with rinse wastewater 302 (previously described as the rinse wastewater 109), so as to obtain a waste liquid 303 to be treated. A carbonate 304 is added to the waste liquid 303 to be treated, so that the carbonate reacts with lithium ions in the waste liquid 303 to be treated to generate a lithium carbonate precipitate 305, thereby recovering lithium element. By using step 6 of the present invention, the lithium element in the cathode material can be further recovered. The MRA used in step 6 to recover lithium carbonate may be calcium and the corresponding MS used is calcium chloride The carbonates used in the present invention are all soluble carbonates, and include, but are not limited to, sodium carbonate, potassium carbonate, sodium bicarbonate and potassium bicarbonate.

In some other embodiments, in the case where the MRA used may be calcium and the corresponding MS used is calcium chloride, step 6 described above may further comprise adding a first amount of carbonate to the waste liquid to be treated, such that calcium ions are precipitated in the form of calcium carbonate, the molar ratio of the first amount of carbonate to the MRA (Ca) being in the range of 1:1 to 1:1.2; then adding a second amount of carbonate to the waste liquid to be treated so as to precipitate lithium ions in the form of lithium carbonate, and recovering lithium carbonate, the mass ratio of the second amount of carbonate to the cathode material being in the range of 0.6 to 2.

In various embodiments of the present invention, the molar ratio of the first amount of carbonate to the MRA (Ca) may be in the range of 1:10 to 1:20, 1:11 to 1:19, 1:12 to 1:18, 1:13 to 1:17. 1:14 to 1:16, 1:10 to 1:12, 1:10 to 1:13, 1:10 to 1:14, 1:10 to 1:15, 1:10 to 1:16, 1:10 to 1:17, 1:10 to 1:18, 1:10 to 1:19, 1:11 to 1:20, 1:12 to 1:20, 1:13 to 1:20, 1:14 to 1:20, 1:15 to 1:20, 1:16 to 1:20, 1:17 to 1:20, 1:18 to 1:20, or 1:19 to 1:20. In different embodiments, the mass ratio of the second amount of carbonate to the cathode material may be in the range of 0.8 to 2, 0.7 to 1.9, 0.8 to 1.8, 0.9 to 1.7, 1.0 to 1.6. 1.1 to 1.5, 1.2 to 1.4, 0.6 to 1.9, 0.6 to 1.8, 0.6 to 1.7, 0.6 to 1.6, 0.6 to 1.5, 0.6 to 1.4, 0.6 to 1.3, 0.6 to 1.2, 0.6 to 1.1, 0.7 to 2, 0.8 to 2, 0.9 to 2, 1.0 to 2, 1.1 to 2, 1.2 to 2, 1.3 to 2, 1.4 to 2, or 1.5 to 2.

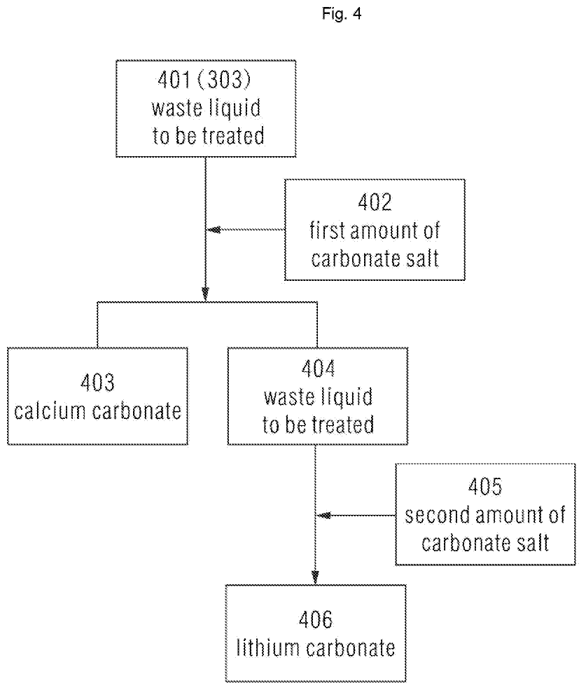

Referring to FIG. 4, in a particular embodiment, a first amount of carbonate 402 may be added to the liquid waste 401 to be treated (previously described as the waste liquid 303 to be treated) such that calcium ions, which more readily form a precipitate with carbonate, precipitate first at a rate in the form of calcium carbonate 403, wherein the molar ratio of the first amount of carbonate to MRA (Ca) is in the range of 1:1 to 1.1.2. Within the molar ratio range above, the carbonate may only form a calcium carbonate precipitate with calcium without affecting other cations in the waste liquid to be treated. After calcium is completely precipitated and separated, a second amount of carbonate 405 is added to the waste liquid 404 to be treated, wherein the mass ratio of the second amount of carbonate to the cathode material is greater than 0.6. Thus, lithium ions in the waste liquid to be treated are also recovered by forming lithium carbonate 406 as a precipitate. By this embodiment, lithium element in the cathode material and calcium element in MRA can be further recovered

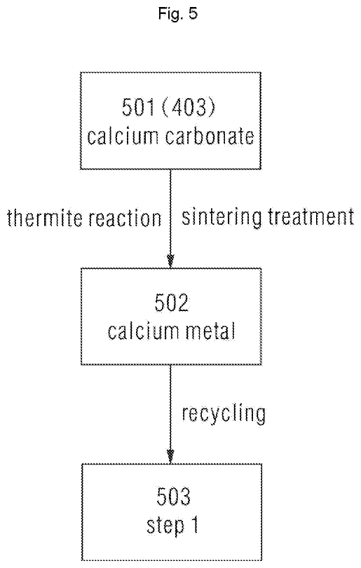

After recovering calcium carbonate according to the foregoing embodiment, the precipitated calcium carbonate may be subjected to sintering treatment and thermite reaction to obtain calcium metal, and the obtained calcium metal may be used as the MRA of step 1. Referring to FIG. 5, in a specific embodiment, calcium carbonate 501 (previously described as the calcium carbonate 403) is subjected to sintering treatment to obtain CaO, and then the obtained CaO is subjected to a thermite reaction to obtain calcium metal 502 The resulting calcium metal can be recovered and used as the MRA and in step 1 (503). Thus, in the case of using the method for recovery of cathode materials according to the present invention, it is possible to completely recover all used materials without causing environmental pollution and material waste.

In another typical embodiment of the invention, provided is a cathode material prepared from an alloy which is recovered by the method for recovery of cathode materials as hereinbefore described.

In another typical embodiment of the invention, provided is an electric vehicle comprising the cathode material previously described herein.

### EXAMPLES

### Example 1

Lithium ion batteries (new NMC622 battery) were disassembled to obtain the battery cathode. Nickel cobalt lithium manganate (LiNi_{0.5}Mn_{0.2}Co_{0.2}O₂,) was mechanically removed from the aluminum substrate of the battery cathode, and polyvinylidene difluoride (PVDF) binder was removed by burning in air to obtain a cathode material of the lithium ion secondary batteries (containing only nickel cobalt lithium manganate). In a glovebox, 1 g of powdered cathode material was placed in 18 g of molten CaCl₂ (MS) at a temperature of about 850° C., in a Molybdenum crucible, where the cathode material powder was deposited at the bottom of the vessel. Then, 0.9 g of calcium metal as the metal reducing agent (MRA) was added. As the solubility of calcium metal in CaCl₂ is 3 mol %, in the melting system, CaCl₂ was used as a solvent and a carrier of calcium metal. In addition, the melting temperature of CaCl₂ used as the MS was about 772° C., and the temperature of calcium metal used as the metal reducing agent (MRA) was 842° C., thereby ensuring that the metal reducing agent (MRA) was completely molten in the MS and fully contacted with the cathode material. The experiment was carried out within a glove box filled with argon, ensuring an oxygen concentration of 15 ppm and a moisture containment level of 2.4 ppm.

In this system, the reduction reaction occurred is as follows:

3Ca+2LiNiₓMn₇Co_{(1-x-y)}O₂=3CaO+Li₂O+2xNi+2yMn+2(1−x−y)Co.

The solubility of CaO as a reaction by-product in CaCl₂ is 25 mol %, so in this example, CaCl₂ can also be used as an extraction agent for CaO as a by-product.

After completion of the reaction (about 60 min), an MS solution and a precipitate were obtained (at the bottom of the MS solution). The system is naturally cooling down to room temperature, and subsequently, the crucible was removed from the glovebox. In order to dissolve the obtained substances (containing CaCl₂, CaO, and Li₂O), the MS solution and precipitate were separated, the precipitate is added to 1.5 liters of deionized (DI) water. The magnetic extraction method is employed to collect the alloys settled at the bottom of the beaker. The resulting alloy product was rinsed with 250 ml of DI water and subsequently dried using a vacuum chamber. To assess the metallic purity, ICP-MS technology was utilized.

The total amount of solid product obtained was 0.525 grams, with a calculated recovery rate of 90%. The purity of the products was determined to be 99.4%.

As can be determined from the results of Example 1, in the case where the method for recovery of cathode materials according to the present invention is used, the recovery rate of an important metal mixture (cobalt, nickel, and manganese) recovered was 90%. Furthermore, the method of the invention is environmentally friendly, it makes it possible to recycle all raw materials without discharging exhaust gases or waste liquids contaminating the environment.

The contents above are only the preferred embodiments of the present invention, and are not intended to limit the present invention. For those skilled in the art, the present invention may have various modifications and variations. Any modifications, equivalent replacements, improvements and the like made within the spirit and principle of the present invention shall belong to the protection scope of the present invention.

1. A method for recovery of cathode materials, comprising:
Step 1, adding cathode materials and a metal reducing agent (MRA) to a molten salt (MS), the cathode materials and the MRA performing a reduction reaction in MS to obtain precipitates and MS solutions.

2. The method for recovery of cathode materials according to claim 1, wherein the operating temperature of the reduction reaction in step 1 is higher than the melting temperature of the MS.

3. The method for recovery of cathode materials according to claim 2, wherein the operating temperature of the reduction reaction in step 1 is 50-100° C. higher than the melting temperature of the MS.

4. The method for recovery of cathode materials according to claim 1, wherein the operating temperature of the reduction reaction in step 1 is in the range of 500-900° C.

5. The method for recovery of cathode materials according to claim 1, wherein in the step 1, the MS can dissolve at least 2 mole % of the MRA, and can dissolve at least 20 mole % of an MRA oxide.

6. The method for recovery of cathode materials according to claim 1, wherein the MRA and the MS have at least one same metal element.

7. The method for recovery of cathode materials according to claim 1, wherein the MRA and the MS are the combination selected from the following group:
elemental lithium and lithium chloride, elemental potassium and potassium chloride, elemental calcium and calcium chloride, elemental calcium and calcium fluoride, elemental aluminum and sodium hexafluoroaluminate, and elemental calcium and a eutectic mixture of calcium chloride and calcium fluoride.

8. The method for recovery of cathode materials according to claim 1, wherein the MS is single molten salt or eutectic molten salt.

9. The method for recovery of cathode materials according to claim 1, wherein the weight ratio of the cathode materials to the MRA is less than 1.3.

10. The method for recovery of cathode materials according to claim 1, wherein the weight ratio of the MS to the cathode materials is in the range of 7.5 and 55.

11. The method for recovery of cathode materials according to claim 1, wherein the MRA used in step 1 is calcium and the MS is calcium chloride.

12. The method for recovery of cathode materials, according to claim 11, the method further comprising:
Step 2, leaching the precipitates using an organic solvent, so as to obtain a first supernatant and a first filter product; and
Step 3, rinsing the first filter product to obtain a solid product and rinse wastewater, wherein the solid product is a metal alloy apart from lithium.

13. The method for recovery of cathode materials according to claim 12, wherein the operating temperature of the step 2 is in the range of 50-100° C.

14. The method for recovery of cathode materials according to claim 12, wherein the rinsing of the step 3 is performed with deionized water at room temperature.

15. The method for recovery of cathode materials according to claim 1, wherein the cathode materials are obtained by the following steps:
disassembling the secondary battery to obtain a cathode, removing the cathode electrode current collector and a binder from the cathode, so as to obtain the cathode materials.

16. The method for recovery of cathode materials according to claim 12, wherein the organic solvent comprises dimethyl sulfoxide (DMSO), formamide, ethylene carbonate, propylene carbonate, and ethylenediamine.

17. The method for recovery of cathode materials according to claim 12, wherein the method further comprises the following steps:
Step 4, cooling the MS solutions obtained in step 1 to obtain a solid salt, and then using an organic solvent to leach the solid salt, so as to obtain a second supernatant and a second filter product; and
Step 5, mixing the first supernatant with the second supernatant to obtain a mixed supernatant, and vacuum distilling the mixed supernatant to recover the organic solvent and the molten salt.

18. The method for recovery of cathode materials according to claim 17, wherein the recovered organic solvent is used as the organic solvent in step 2 and/or the recovered molten salt is used as the MS in step 1.

19. The method for recovery of cathode materials according to claim 17, wherein the method further comprises the following step:
Step 6, mixing the second filter product with the rinse wastewater obtained from the step 3 to obtain a waste liquid to be treated, and adding a carbonate salt into the waste liquid to be treated, so as to recover lithium carbonate.

20. The method for recovery of cathode materials according to claim 19, wherein step 6 further comprises:
adding a first amount of carbonate salt to the waste liquid to be treated, so as to precipitate calcium ions in the form of calcium carbonate, the molar ratio of the first amount of carbonate salt and the MRA (Ca) being in the range of 1:1-1:1.2; then adding a second amount of carbonate salt to the waste liquid to be treated, so as to precipitate lithium ions in the form of lithium carbonate, and recovering the lithium carbonate, the weight ratio of the second amount of carbonate salt and the cathode materials being in the range of 0.6 and 2.

21. The method for recovery of cathode materials according to claim 20, wherein the precipitated calcium carbonate is subjected to sintering treatment and thermite reaction to obtain calcium metal, and the obtained elemental calcium can be used as the MRA of step 1.
